(19) United States
(12) Patent Application Publication
(10) Pub. No.: US 2026/0142921 A1
(43) Pub. Date: May 21, 2026

(54) Border Gateway Protocol Outbound Route Filtering Using Community Attribute

(71) Applicant: Ciena Corporation, Hanover, MD (US)

(72) Inventors: Anil Dharmshaktu, New Delhi (IN); Parul Saini, Gurugram (IN); Param Preet Dhillon, Gurugram (IN); Varun Munjal, Gurugram (IN)

(73) Assignee: Ciena Corporation, Hanover, MD (US)

(21) Appl. No.: 19/006,465

(22) Filed: Dec. 31, 2024

(30) Foreign Application Priority Data
Nov. 18, 2024 (IN) 202411089254

(51) Int. Cl. H04L 45/748; H04L 45/02

(52) U.S. Cl. CPC H04L 45/748; H04L 45/04

(57) ABSTRACT

Systems and methods for border gateway protocol (BGP) outbound route filtering (ORF) using community attribute include, responsive to tagging one or more prefixes in border gateway protocol (BGP) with one or more community attributes for outbound route filtering (ORF) in a network, transmitting a single route refresh message with the one or more community attributes to a BGP peer router for purposes of the BGP peer router applying the ORF based on the one or more community attributes; and receiving prefixes from the BGP peer router based on the ORF applied at the BGP peer router.

### FIELD OF THE DISCLOSURE

The present disclosure relates generally to networking. More particularly, the present disclosure relates to systems and methods for border gateway protocol (BGP) outbound route filtering (ORF) using community attribute.

### BACKGROUND OF THE DISCLOSURE

Prefix-based ORF is a mechanism in BGP used by routers to communicate and apply route filtering preferences with their BGP peers. See, e.g., RFC 2918, “Route Refresh Capability for BGP-4,” September 2000, RFC 5291, “Outbound Route Filtering Capability for BGP-4,” August 2008, and RFC 5292, “Address-Prefix-Based Outbound Route Filter for BGP-4,” August 2008, the contents of which are incorporated by reference in their entirety, This feature allows routers to exchange ORF capabilities, which specify the types of routes a router is willing to receive from its peers. By implementing ORF, routers can significantly reduce the volume of BGP updates transmitted between peers. This reduction is achieved by filtering out unnecessary or irrelevant routing information at the source, thus preventing unwanted updates from even being sent. This approach not only reduces the load on network bandwidth but also minimizes the computational and memory resources required for processing updates, as routers are spared from handling unnecessary routing information. Overall, ORF enhances the efficiency and scalability of BGP operations, contributing to more stable and manageable network environments, especially in large or complex networks.

### BRIEF SUMMARY OF THE DISCLOSURE

The present disclosure relates to systems and methods for BGP ORF using community attribute. Specifically, the proposed solution introduces a novel mechanism for filtering BGP routes using a single route refresh message, thereby enhancing performance for both the sender and receiver. This streamlined approach reduces the volume and complexity of communication between BGP peers, leading to faster convergence times within the network. By controlling BGP's processor and memory usage, this solution is particularly advantageous in scaled environments where resource management is crucial.

In an embodiment, a network includes a border gateway protocol (BGP) router with circuitry configured to, responsive to tagging one or more prefixes in BGP with one or more community attributes for outbound route filtering (ORF) in a network, transmit a single route refresh message with the one or more community attributes to a BGP peer router for purposes of the BGP peer router applying the ORF based on the one or more community attributes; and receive prefixes from the BGP peer router based on the ORF applied at the BGP peer router. The circuitry can be further configured to, prior to the single route refresh message being transmitted, negotiate with the BGP peer router a prefix-based ORF capability where the one or more community attributes are used. The circuitry can be further configured to performing the tagging the one or more prefixes and propagating the one or more prefixes with the one or more community attributes in the network. The single route refresh message can include an address family identifier (AFI), subsequent AFI (SAFI), a when to refresh value, and a list of the one or more community attributes.

The one or more community attributes can be tagged such that the BGP peer router does not send any prefixes with the one or more community attributes. The circuitry can be further configured to utilizing one or more different community attributes for prioritizing associated prefixes. The single route refresh message can be based on RFC 2918. The single route refresh message can include at least a million prefixes for the ORF. The network can also include the BGP peer router which includes circuitry configured to, subsequent to the single route refresh message being transmitted, receive the single route refresh message, determine the single route refresh message includes the ORF based on the one or more community attributes, and filter and transmit the prefixes at the BGP peer router based on the one or more community attributes.

In another embodiment, a method with steps and a non-transitory computer-readable medium stores instructions that, when executed, cause circuitry to perform the steps, and the steps include, responsive to tagging one or more prefixes in border gateway protocol (BGP) with one or more community attributes for outbound route filtering (ORF) in a network, transmitting a single route refresh message with the one or more community attributes to a BGP peer router for purposes of the BGP peer router applying the ORF based on the one or more community attributes; and receiving prefixes from the BGP peer router based on the ORF applied at the BGP peer router. The steps can further include, prior to the transmitting, negotiating with the BGP peer router a prefix-based ORF capability where the one or more community attributes are used. The steps can further include performing the tagging the one or more prefixes and propagating the one or more prefixes with the one or more community attributes in the network.

The single route refresh message can include an address family identifier (AFI), subsequent AFI (SAFI), a when to refresh value, and a list of the one or more community attributes. The one or more community attributes can be tagged such that the BGP peer router does not send any prefixes with the one or more community attributes. The steps can further include utilizing one or more different community attributes for prioritizing associated prefixes. The single route refresh message can be based on RFC 2918. The single route refresh message can include at least a million prefixes for the ORF. The steps can further include, at the BGP peer router and subsequent to the transmitting, receiving the single route refresh message; determining the single route refresh message includes the ORF based on the one or more community attributes; and filtering and transmitting the prefixes at the BGP peer router based on the one or more community attributes.

### BRIEF DESCRIPTION OF THE DRAWINGS

The present disclosure is detailed through various drawings, where like components or steps are indicated by identical reference numbers for clarity and consistency.

FIG. 1 illustrates an example network with two interconnected routers for describing BGP ORF.

FIG. 2 illustrates a flowchart of a process for border gateway protocol (BGP) outbound route filtering (ORF) using the community attribute.

FIG. 3 illustrates a block diagram of a router depicted in a simplified functional format.

FIG. 4 illustrates a block diagram of an example processing device.

### DETAILED DESCRIPTION OF THE DISCLOSURE

Again, the present disclosure introduces a novel mechanism for filtering BGP routes using a single route refresh message, thereby enhancing performance for both the sender and receiver. This streamlined approach reduces the volume and complexity of communication between BGP peers, leading to faster convergence times within the network. By controlling BGP's processor and memory usage, this solution is particularly advantageous in scaled environments where resource management is crucial. Central to this approach is route filtering based on communities received within the route refresh message. The solution enables a BGP router to encapsulate community lists—including standard, extended, and large communities—within an Outbound Route Filtering (ORF)-based route refresh message. This encapsulation ensures that only relevant routes are transmitted, filtering them at the source based on community criteria and thus conserving resources.

The proposed solution introduces a new ORF capability that BGP speakers can negotiate to enable each peer to encode and decode an enhanced route refresh message format. This capability allows BGP routers to selectively filter and share routing information based on community-based policies, which improves route processing efficiency. By embedding community lists—such as standard, extended, and large communities—within a single ORF-based route refresh message, the solution minimizes unnecessary routing updates, thereby reducing system load on both the sender and receiver sides. This approach not only provides resource efficiency but also offers significant scalability benefits, especially in networks with a large number of prefixes. By reducing BGP's processor and memory usage in scaled setups, the solution enhances network performance and convergence time, even as the number of prefixes grows. In addition, the minimal configuration required reduces operational overhead for network administrators, making the solution easier to deploy and maintain across various network environments. Overall, the proposed ORF capability enables BGP networks to scale more effectively while maintaining stability, resource efficiency, and streamlined management.

BGP ORF provides a powerful mechanism for one BGP peer to specify a prefix list that its neighboring peer should use to filter outbound routes. Essentially, this allows a BGP router to inform its neighbor about routes that should not be advertised, thereby reducing unnecessary BGP updates and decreasing the size of local BGP routing tables. This approach not only conserves bandwidth but also improves overall network efficiency by limiting the volume of routing information each router must process and store.

The prefix-based ORF mechanism is enabled through the exchange of ORF capability advertisements between BGP peers. When a BGP router advertises ORF capabilities, it signals to its neighbor that it is willing to accept a prefix list from the neighbor and apply it to locally configured outbound route filters (if any exist). This capability allows a BGP speaker to install an inbound prefix filter on a remote peer as an outbound filter, thereby actively controlling the flow of routing updates based on the specific needs of the network.

When the ORF capability is enabled, it helps both BGP peers filter out unwanted routes at the source, preventing them from even entering the network. This is particularly beneficial in large networks with complex routing needs, as it reduces CPU and memory load on BGP routers, improves convergence times, and enhances the scalability and stability of the network. By limiting unnecessary route propagation through ORF, networks experience more streamlined operations, leading to more responsive and efficient routing environments.

FIG. 1 illustrates an example network 10 with two interconnected routers 12A, 12B for describing BGP ORF. The network 10 includes two autonomous systems (AS) AS 100, AS 200, with the router 12A in the AS 100 and the router 12B in the AS 200. In this example, the AS 200 has an upstream peering with the AS 100. For illustration purposes, Let's suppose that the AS 200 only wants to receive filtered routes from the AS 100. Traditional filtering would dictate that on AS 200 router 12B, a prefix-list along with routing-policy would be configured and applied as inbound. Although the filtering goal is achieved, efficiency is not. The AS 100 would continue to send whole public BGP table of millions of routes and the AS 200 would have to process every update message just to discard it and only accept few routes which are part of prefix-list. This is where BGP ORF is used.

The ORF capability describes an optimization on how prefix filtering can occur between the BGP routers 12A, 12B. With BGP ORF, the downstream router 12B dynamically tells the upstream router 12A what routes to filter *outbound*. This means that the downstream router 12B will only receive update messages about the prefixes that it wants. After negotiating the prefix-based ORF capability with the router 12A, the router 12B adds the local prefix-based import policies to a route refresh message and sends the message to the router 12A.

A route refresh message is a control message used to request the re-advertisement of routing information from a BGP peer without requiring a complete reset of the BGP session. This mechanism allows the router 12B to receive an updated view of the routes being advertised by its peer, the router 12A, facilitating route adjustments or policy changes dynamically and without disrupting existing connections. Prior to the introduction of route refresh, updating route policies often required a session reset, which could interrupt traffic flow and lead to temporary routing instability. The route refresh capability, standardized in RFC 2918, resolves this by allowing a BGP router to request an update to its routing table when policies or filters change, without impacting the overall session. When the router 12B sends a route refresh message to its peer, it prompts the peer router 12A to resend its routing information. This is especially useful when new filters or changes in routing policies are applied, as it ensures the router receives an updated set of routes that conform to the latest policies. This process enhances BGP's flexibility and operational efficiency by allowing real-time updates and adjustments to routing policies in response to network conditions, policy changes, or scaling needs. As a result, route refresh messages play a critical role in maintaining efficient and responsive network operations in modern BGP deployments.

With ORF, the router 12A optimizes the exchange of routing information by constructing export policies dynamically based on a route refresh message received from its peer, router 12B. Through this process, the router 12A sends only the specific routes that router 12B has indicated as necessary. This selective sharing ensures that the router 12B receives only the routes it requires, minimizing the volume of unnecessary routing information and thus improving the efficiency of the routing process. A significant benefit of this approach is that the router 12A does not need to maintain long-term, static routing policies for its peers. Typically, a BGP router must retain policy configurations dictating which routes to share or block with each peer, requiring storage and processing resources. However, with ORF, the router 12A constructs and applies export policies on demand based on the preferences signaled in the route refresh message from the router 12B. This eliminates the need for the router 12A to maintain dedicated routing policies for individual peers, reducing configuration complexity and memory usage.

This on-demand filtering capability also enhances network scalability and adaptability. Because the router 12A does not have to manage and store fixed policy configurations, it can more easily accommodate changes in network topology or routing requirements. In scenarios where multiple BGP peers request different sets of routes, ORF enables the router 12A to respond to each peer's specific needs without a static policy for each, providing a more flexible, efficient, and resource-conscious approach to route management.

ORF allows a router to signal its routing preferences to a neighboring router, specifically regarding which prefixes it wants to receive or avoid receiving. Instead of passively accepting all advertised routes and applying filters afterward, a BGP router using ORF can proactively tell its peer which prefixes it does not need, minimizing unnecessary routing updates. This approach improves efficiency by reducing bandwidth usage and conserving processor and memory resources since the receiving router only processes the routes it actually requires. ORF works by enabling one BGP router to send a list of filtering criteria to its peer. This list, often based on attributes like IP prefix, autonomous system (AS) path, or community tags, specifies the prefixes the router either wants to receive or exclude. For example, if the router 12B does not want to receive specific prefixes from the router 12A, it can send an ORF message to the router 12A with the list of unwanted prefixes. The router 12A, upon receiving this ORF message, will filter out the specified prefixes from its advertisements to the router 12B, effectively applying the router 12B's preferences at the source. This “filter-at-the-source” capability streamlines routing operations, especially in large-scale networks with complex routing policies. By using ORF, network operators can avoid having to configure extensive filters manually on each router, as ORF dynamically adjusts route advertisements based on the preferences exchanged between routers. This results in more efficient route management, faster convergence times, and reduced operational overhead.

The current solution faces scalability limitations when filtering a large number of routes in BGP. To filter multiple routes effectively, users are required to create multiple prefix lists, which can become cumbersome and complex to manage, especially as the network grows. Additionally, there is often overlap in attributes among these routes, such as common autonomous system (AS) paths, which could potentially be consolidated to simplify the filtering process. However, without such consolidation, the management and organization of prefix lists become increasingly challenging as the network expands. Another critical issue arises with the route refresh process. BGP messages are limited to a maximum size of 4096 bytes, which restricts the number of prefixes that can be included in a single route refresh message. When a large number of routes need to be refreshed, BGP may need to send multiple route refresh messages to convey all the necessary prefixes, resulting in increased overhead and greater processing demand on both the sender and receiver. This fragmented approach can lead to inefficiencies in resource usage, slowing down convergence times and adding strain to processor and memory resources.

In high-scale environments, where thousands of routes may need to be managed and filtered, this lack of scalability can impact network performance, stability, and administrative efficiency. The repetitive nature of writing numerous prefix lists and handling fragmented route refresh messages introduces potential for configuration errors and network inefficiencies. To support more scalable and streamlined BGP operations, there is a need for solutions that can handle larger numbers of routes with common attributes more efficiently, ideally through more compact, attribute-based filtering mechanisms that reduce the need for repetitive, individual prefix configurations.

The BGP community attribute is a versatile, optional, and transitive attribute used to categorize and control groups of routes within a network. By tagging prefixes with specific community values, network administrators can apply routing policies uniformly to all prefixes within a given community, simplifying the management of large-scale networks. This attribute allows prefixes that share common characteristics or require similar handling to be grouped under a common label or “community,” enabling administrators to adjust routing decisions efficiently. For example, a community attribute can be used to mark routes that should be given priority, those that need to be filtered for certain peers, or routes that require specific path preferences such as higher or lower local preference values. As a transitive attribute, the BGP community is designed to propagate across BGP peers, meaning it can be shared with and recognized by multiple routers across different parts of a network or even across different networks if permitted by policy. The flexibility of BGP communities makes them an essential tool in modern BGP deployments, allowing ISPs, enterprises, and other network operators to manage traffic patterns, enforce security policies, and influence route selection dynamically and at scale. By defining common behaviors based on community tags, networks can respond to changes more quickly and maintain consistent policy application without requiring manual configuration for each individual prefix. This capability enhances the scalability, efficiency, and control of routing policies in complex network environments.

Accordingly, the present disclosure includes use of the BGP community attribute for ORF to reduce operator workload and to allow multiple prefixes to be filtered with a single BGP route refresh message. This approach streamlines operations by enabling groups of routes with shared characteristics to be tagged and filtered collectively, eliminating the need for creating and maintaining numerous individual prefix lists. The BGP community attribute functions as a tagging mechanism that marks prefixes based on shared properties or desired routing behaviors. It is an optional, transitive attribute, meaning that if it is present, it will be propagated to all BGP neighbors, allowing the tag to remain intact across various network segments. This propagation ensures that the community attribute can be utilized across the network to manage routing behavior in a consistent and scalable manner.

Network operators and customers frequently use the BGP community attribute internally to categorize prefixes by shared traits or routing policies. For instance, an operator can tag prefixes that should be treated similarly, such as those requiring a specific local preference or those that should be filtered out for certain peers. By marking these prefixes with a common community attribute, operators can apply broad routing policies with minimal configuration, such as filtering, route prioritization, or setting specific path preferences.

Implementing ORF based on community attributes provides a scalable solution for filtering routes, especially in large networks where maintaining separate prefix lists for each filtering requirement would be inefficient. With community-based ORF, operators can easily manage a wide array of prefixes under a unified policy, reducing administrative complexity and optimizing resource utilization. This method also enables more flexible and dynamic routing policy applications, making it ideal for environments that demand high scalability and streamlined operations.

Prefixes can be tagged with the same community attribute in BGP by applying a common community value to each of those prefixes. This tagging is typically done through route maps or policy statements configured on BGP routers 12A, 12B. By assigning a shared community attribute to prefixes that need similar routing treatment, network operators can easily manage routing policies for these prefixes as a group rather than individually. For example, consider a network where certain prefixes need to be routed with a high priority. Instead of setting individual policies for each prefix, an operator can create a route map or policy statement that tags each of these prefixes with a community attribute, such as 65000:100. Here, 65000 typically represents an Autonomous System (AS) number, while 100 is a value chosen to represent a particular routing policy or preference. This community tag can then be referenced by other policies across the network, allowing routers to recognize and apply the desired routing actions (such as prioritizing, filtering, or assigning a specific local preference) to all prefixes marked with 65000:100.

This process involves configuring the router to match specific prefixes and set the community attribute accordingly. Once tagged, any BGP router that recognizes this community can treat the tagged routes according to the policy associated with that community value. This uniform tagging mechanism simplifies the application of routing policies on a large scale, enabling efficient management and consistent behavior across numerous prefixes.

The following table is an example format of ORF information in route refresh message as per BGP RFC 2918. A new ORF type can be used to send the community information to remote BGP peer.

Address Family Identifier (2 octets)
Reserved (1 octet)
Subsequent Address Family Identifier (1 octet)
When-to-refresh (1 octet)
ORF Type (1 octet)
Length of ORF entries (2 octets)
First ORF entry (variable)
Second ORF entry (variable)
. . .
N-th ORF entry (variable)
ORF Type (1 octet)
Length of ORF entries (2 octets)
First ORF entry (variable)
Second ORF entry (variable)
. . .
N-th ORF entry (variable)
ORF Type (1 octet)
. . .

A new community capability can be introduced to support this enhanced type of ORF route refresh message, which includes community information. This new capability allows BGP speakers to use community attributes in ORF messages, enabling more efficient filtering by grouping routes with shared attributes. With this capability, BGP routers can use community tags to represent a set of prefixes, simplifying route management and reducing the need for individual prefix specifications in route filtering. For this new ORF community capability to function, BGP speakers (routers that use BGP to exchange routes) must advertise and negotiate the capability during their initial session establishment. This negotiation ensures that both routers in the BGP session understand and support the encoding, decoding, and processing of the new community-based ORF route refresh messages. By exchanging this capability during the BGP session setup, each router confirms that it can interpret community attributes within route refresh messages and apply the corresponding filtering policies accurately.

Once this new ORF community capability is enabled, the routers 12A, 12B can efficiently signal route filtering requests by sending route refresh messages containing specific community attributes. This approach greatly enhances scalability and reduces configuration complexity, as multiple prefixes with shared characteristics can be filtered as a group. The ability to encode and decode community-based ORF route refresh messages also helps maintain network performance by reducing unnecessary route advertisements, saving bandwidth, and lowering processor and memory usage on the BGP routers 12A, 12B. Overall, this new ORF community capability enables BGP networks to handle large-scale routing policies with greater flexibility and efficiency, making them more adaptable to dynamic network environments.

The community attribute can be incorporated into a route refresh message to signal a set of prefixes for ORF. This approach allows a BGP router 12B to specify a filter for certain prefixes without requiring individual prefix listings, using community attributes to group routes based on common characteristics. When a BGP peer router 12A receives a route refresh message containing a community attribute, it interprets the message as a directive to filter all routes tagged with that community attribute. Here's how it works in an example: suppose the router 12B wants to control the routes it receives from the router 12A based on certain shared properties, like geographical origin or AS path. Instead of specifying each individual prefix, the router 12B sends a route refresh message to the router 12A, containing a community attribute that represents this specific set of routes. The router 12A then interprets this message and dynamically applies the community-based filter to its outbound updates to the router 12B. As a result, the router 12A will only send the routes that match the specified community attribute, reducing the volume of unnecessary routing information.

This method streamlines the ORF process by consolidating prefixes with shared characteristics under a single community tag. It eliminates the need for complex, prefix-specific configuration, reducing administrative overhead and improving scalability, especially in large networks. By using community attributes in route refresh messages, network operators can implement flexible and efficient route filtering policies that are easier to maintain and adapt to changing network requirements.

In BGP, a prefix represents a specific range of Internet Protocol (IP) addresses, usually defined by an IP address and subnet mask, that identifies a block of addresses within a network. A route, in BGP terms, is an advertised path to reach a prefix. Each route includes information about how to reach the prefix, such as the next-hop IP address and various BGP attributes like the autonomous system path, which indicates the path taken across networks to reach the destination. Routes to the same prefix can vary based on different attributes, allowing BGP to select the optimal path according to network policies and metrics.

Again, to streamline the management of multiple prefixes, prefixes requiring similar routing policies can be grouped under a shared BGP community attribute. This attribute is a tag applied to routes that identify prefixes with a common characteristic or policy, making it easier to manage and apply consistent actions to these prefixes network-wide. For example, a set of prefixes that should be given high priority can be tagged with a community attribute, such as 65000:200, where 65000 is the AS number, and 200 is a custom identifier for that policy. This tagging is typically performed on the router originating the prefixes, using route maps or policy statements that assign the community attribute to each route for the relevant prefixes.

Once the prefixes are tagged, BGP propagates these routes—including their community attributes—to neighboring routers, which then pass them along the network 10. This allows every router in the BGP network to learn not only the prefixes but also their associated community attributes. With this shared knowledge, routers can apply uniform policies, such as prioritization or filtering, to all routes with the specified community attribute, ensuring consistent handling of routes associated with those prefixes throughout the network.

In BGP, community attributes are typically 32-bit values, structured as two 16-bit sections: the first usually represents an autonomous system (AS) number, and the second is an identifier specific to that AS. This 32-bit structure theoretically allows for over 4 billion (2\hat{ }32) unique community values. However, in practical terms, the number of different community attributes used in a network is often far fewer, as operators define only those communities necessary for their routing policies. Beyond standard communities, BGP also supports extended and large communities, providing even more options for tagging and managing routes. Extended communities expand the 32-bit limit to 64 bits, which enables more specific tagging, especially useful in multi-AS or complex policy environments. Large communities, introduced more recently, are 96-bit values, formatted as three 32-bit fields, which further enhance flexibility for policy management across global networks. In practice, network operators define a limited set of meaningful community values to categorize routes based on policy needs, such as prioritization, filtering, or regional grouping. This allows operators to use a manageable number of community attributes while still leveraging the potential of BGP communities to streamline routing policies and enhance control over traffic flows.

The present disclosure repurposes the community attribute for the purpose of ORF prefix advertisement; while reusing the fact the community attributes are propagated through the network 10 and known by all routers 12. Using the community attribute is an efficient way to advertise the ORF prefix list in a single route refresh message.

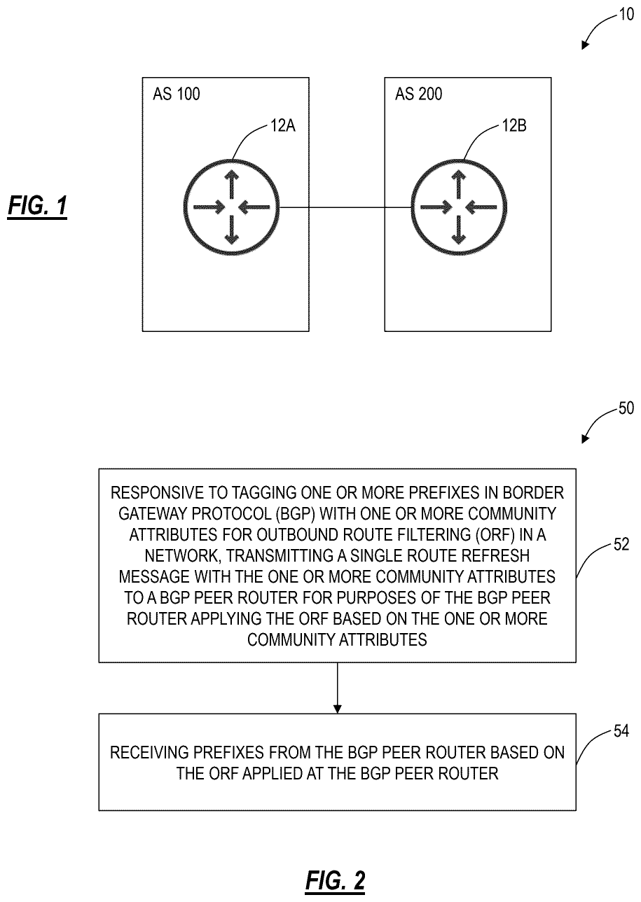

FIG. 2 illustrates a flowchart of a process 50 for border gateway protocol (BGP) outbound route filtering (ORF) using the community attribute. The process 50 contemplates implementation as a method with steps, via circuitry, an apparatus, or the routers 12A. 12B implementing the steps, and as a non-transitory computer-readable medium storing instructions that, when executed, cause circuitry to implement the steps.

The process 50 includes, responsive to tagging one or more prefixes in border gateway protocol (BGP) with one or more community attributes for outbound route filtering (ORF) in a network, transmitting a single route refresh message with the one or more community attributes to a BGP peer router for purposes of the BGP peer router applying the ORF based on the one or more community attributes (step 52); and receiving prefixes from the BGP peer router based on the ORF applied at the BGP peer router (step 54). The process 50 can include, prior to the transmitting, negotiating with the BGP peer router a prefix-based ORF capability where the one or more community attributes are used.

The process 50 can include performing the tagging the one or more prefixes and propagating the one or more prefixes with the one or more community attributes in the network. The single route refresh message can include an address family identifier (AFI), subsequent AFI (SAFI), a when to refresh value, and a list of the one or more community attributes. The one or more community attributes can be tagged such that the BGP router does not send any prefixes with the one or more community attributes. The process 50 can include utilizing one or more different community attributes for prioritizing associated prefixes.

The single route refresh message can be based on RFC 2918. For example, the single route refresh message includes at least a million prefixes for the ORF. The process 50 can also include, at the BGP peer router and subsequent to the transmitting, receiving the single route refresh message; determining the single route refresh message includes the ORF based on the one or more community attributes; and filtering and transmitting the prefixes at the BGP peer router based on the one or more community attributes.

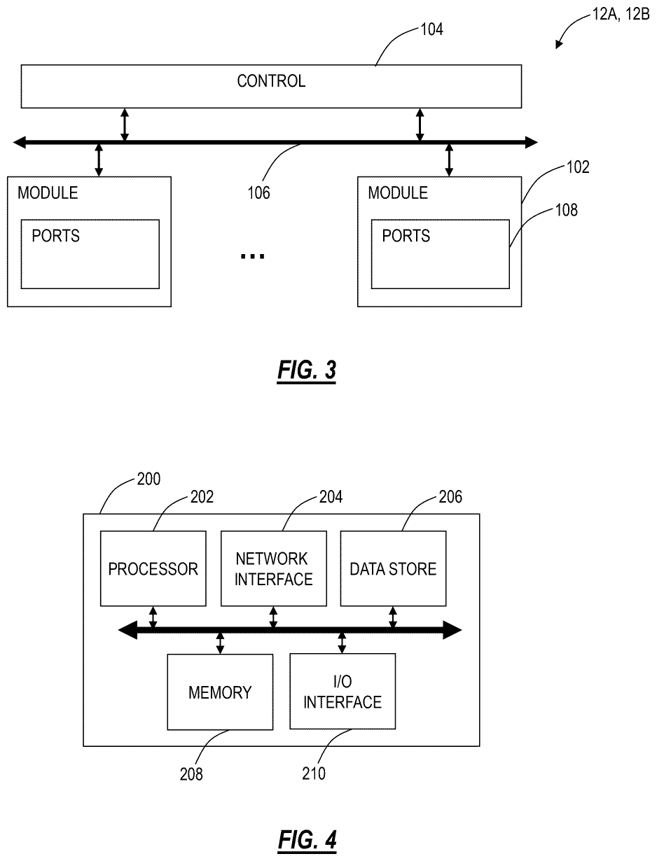

FIG. 3 illustrates a block diagram of a router 12A, 12B, depicted in a simplified functional format. It is important to note that a more practical design of this router would likely include additional components and processing logic to accommodate standard operating features, which are not detailed here. The router 12A, 12B may represent any network element operable in a network using optical and packet protocols, and includes various interconnected modules, such as modules 102 and 104, via an interface 106. These modules, also known as blades or line cards, are typically mounted on the chassis of a data switching device. Each module can house numerous electronic or optical devices on a circuit board, complete with various interconnects, including interfaces to the chassis itself.

Specifically, the diagram illustrates two types of modules: line modules 102, which feature multiple Ethernet ports for external connections, and a control module 104. The line modules facilitate data traffic switching between ports via a switching fabric, integrated across the modules, potentially centralized in a separate unit or module, as well as a combination. This switching fabric includes hardware, software, and firmware that routes incoming data to the appropriate port. The control module 104 is equipped with a microprocessor, memory, software, and a network interface to manage operations such as configuration and monitoring of the router 12A, 12B. It may also communicate with external network management systems or databases that handle provisioning and operational data.

Lastly, while FIG. 3 provides a basic view, those skilled in the art will understand that the router 12A, 12B could include additional components or be configured differently, such as in a distributed arrangement or as an integrated, rack-mounted unit (often referred to as a “pizza-box” configuration). This depiction in FIG. 3 is intended to convey functional aspects, with actual hardware implementations varying widely.

FIG. 4 illustrates a block diagram of an example processing device 200. The processing device 200 may be integrated within the router 12A, 12B or function as a standalone unit connected to the router 12A, 12B. It may also be known as an apparatus, a control module, shelf controller, shelf processor, or system controller. The core of the processing device 200 is a processing unit 202, a hardware unit that runs software instructions. The processing unit 202 could be one or more custom or commercially available processors, i.e., one or more processors. During operation, the processing unit 202 executes software from memory, manages data communication with the memory, and controls the processing device 200 operations based on the software.

The processing device 200 also features several components connected to the processing unit 202: a network interface 204, a data store 206, memory 208, and an I/O interface 210. The network interface 204, possibly an Ethernet device, allows the processing device 200 to communicate over a data network and includes necessary connections for address, control, and data communication. The data store 206 stores various types of data such as telemetry data, OAM&P data, etc., and may include both volatile (e.g., RAM) and nonvolatile (e.g., ROM, hard drives) memory elements. Similarly, the memory 208 includes volatile and nonvolatile storage media, potentially employing a distributed architecture where components are located remotely but accessible by the processing unit 202. The I/O interface facilitates communication between processing device 200 and external devices.

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A network comprising a border gateway protocol (BGP) router with circuitry configured to:
responsive to tagging one or more prefixes in BGP with one or more community attributes for outbound route filtering (ORF) in a network, transmit a single route refresh message with the one or more community attributes to a BGP peer router for purposes of the BGP peer router applying the ORF based on the one or more community attributes, and
receive prefixes from the BGP peer router based on the ORF applied at the BGP peer router.

2. The network of claim 1, wherein the circuitry is further configured to
prior to the single route refresh message being transmitted, negotiate with the BGP peer router a prefix-based ORF capability where the one or more community attributes are used.

3. The network of claim 1, wherein the circuitry is further configured to
performing the tagging the one or more prefixes and propagating the one or more prefixes with the one or more community attributes in the network.

4. The network of claim 1, wherein the single route refresh message includes an address family identifier (AFI), subsequent AFI (SAFI), a when to refresh value, and a list of the one or more community attributes.

5. The network of claim 1, wherein the one or more community attributes are tagged such that the BGP peer router does not send any prefixes with the one or more community attributes.

6. The network of claim 1, wherein the circuitry is further configured to
utilizing one or more different community attributes for prioritizing associated prefixes.

7. The network of claim 1, wherein the single route refresh message is based on RFC 2918.

8. The network of claim 1, wherein the single route refresh message includes at least a million prefixes for the ORF.

9. The network of claim 1, further comprising the BGP peer router which includes circuitry configured to
subsequent to the single route refresh message being transmitted, receive the single route refresh message,
determine the single route refresh message includes the ORF based on the one or more community attributes, and
filter and transmit the prefixes at the BGP peer router based on the one or more community attributes.

10. A method comprising steps of:
responsive to tagging one or more prefixes in border gateway protocol (BGP) with one or more community attributes for outbound route filtering (ORF) in a network, transmitting a single route refresh message with the one or more community attributes to a BGP peer router for purposes of the BGP peer router applying the ORF based on the one or more community attributes; and
receiving prefixes from the BGP peer router based on the ORF applied at the BGP peer router.

11. The method of claim 10, wherein the steps further include
prior to the transmitting, negotiating with the BGP peer router a prefix-based ORF capability where the one or more community attributes are used.

12. The method of claim 10, wherein the steps further include
performing the tagging the one or more prefixes and propagating the one or more prefixes with the one or more community attributes in the network.

13. The method of claim 10, wherein the single route refresh message includes an address family identifier (AFI), subsequent AFI (SAFI), a when to refresh value, and a list of the one or more community attributes.

14. The method of claim 10, wherein the one or more community attributes are tagged such that the BGP peer router does not send any prefixes with the one or more community attributes.

15. The method of claim 10, wherein the steps further include
utilizing one or more different community attributes for prioritizing associated prefixes.

16. The method of claim 10, wherein the single route refresh message is based on RFC 2918.

17. The method of claim 10, wherein the single route refresh message includes at least a million prefixes for the ORF.

18. The method of claim 10, wherein the steps further include
at the BGP peer router and subsequent to the transmitting, receiving the single route refresh message;
determining the single route refresh message includes the ORF based on the one or more community attributes; and
filtering and transmitting the prefixes at the BGP peer router based on the one or more community attributes.

19. A non-transitory computer-readable medium storing instructions that, when executed, cause circuitry to perform steps of:
responsive to tagging one or more prefixes in border gateway protocol (BGP) with one or more community attributes for outbound route filtering (ORF) in a network, transmitting a single route refresh message with the one or more community attributes to a BGP peer router for purposes of the BGP peer router applying the ORF based on the one or more community attributes; and
receiving prefixes from the BGP peer router based on the ORF applied at the BGP peer router.

20. The non-transitory computer-readable medium of claim 19, wherein the steps further include
prior to the transmitting, negotiating with the BGP peer router a prefix-based ORF capability where the one or more community attributes are used.
